(19) United States
(12) Patent Application Publication
(10) Pub. No.: US 2025/0253788 A1
(43) Pub. Date: Aug. 7, 2025

(54) SENSORLESS CONTROL METHOD OF PERMANENT MAGNET SYNCHRONOUS MOTOR

(71) Applicant: ZHEJIANG UNIVERSITY OF TECHNOLOGY, Zhejiang (CN)

(72) Inventors: Jianfeng Mao, Zhejiang (CN); Yinghao Hu, Zhejiang (CN); Xu Zhang, Zhejiang (CN); Fujiong Zhao, Zhejiang (CN); Hongjin Chen, Zhejiang (CN); Yuchen Wang, Zhejiang (CN)

(73) Assignee: ZHEJIANG UNIVERSITY OF TECHNOLOGY, Zhejiang (CN)

(21) Appl. No.: 18/433,474

(22) Filed: Feb. 6, 2024

(51) Int. Cl. H02P 21/13; H02P 21/18; H02P 21/22

(52) U.S. Cl. CPC H02P 21/13; H02P 21/18; H02P 21/22; H02P 2207/055

(57) ABSTRACT

A sensorless control method and a system for PMSM based on Luenberger observer. The system includes a power supply circuit, a sampling circuit, a main control circuit and a drive circuit. The power supply circuit supplies power to other circuits. The sampling circuit is used to obtain the three-phase current of the motor. The main control circuit outputs the control signal to the drive circuit to run the PMSM. The present invention uses an improved method for selecting the feedback coefficient of Luenberger observer, which makes the selection of Luenberger observer feedback coefficient more convenient and effective. Moreover, it can select optimal parameters globally based on this method, leading to adaptive adjustment of feedback coefficients for better observer performance when the rotational speed influences the position of the pole of the observer.

### TECHNICAL FIELD

The present disclosure belongs to the technical field of PMSM (permanent magnet synchronous motor) control, and specifically relates to a sensorless control method and system of PMSM based on a new Luenberger observer.

### BACKGROUND

PMSM has the advantages of good dynamic response, large torque and high efficiency, which is widely used in the power machinery field. In order to realize the accurate control of PMSM, it is necessary to obtain accurate rotor position. Therefore, the position sensor is used by the traditional method to obtain rotor position. But this traditional method has some disadvantages, such as low reliability, vulnerability to external environment, additional cost and weight, and so on. For sensorless motors, the rotor position can be obtained through the signal of back electromotive force (back-EMF), using sensorless control algorithm. More specifically, the estimated rotor speed and angle can be obtained by the position observer, which needs the physical quantities such as voltage and current. As for sensorless motors, the cost of the device is relatively low, and its sensitivity to evironmental conditions is reduced, making the PMSM control more reliable. In recent years, the sensorless control algorithm has been greatly promoted in the field of motor control due to its superiority.

Luenberger observer is a linear full-order state observer, which has the advantages of fast dynamic response and high estimation accuracy. In the sensorless control of PMSM, Luenberger observer is commonly used to estimate the rotor position. The key of designing Luenberger observer is to select the appropriate feedback coefficients which have a great influence on the rotor position estimation accuracy as well as its convergence rate. However, because of the nonlinear characteristics of PMSM system, it is difficult to use the pole placement method (PPM) to get the feedback coefficients. Usually, the feedback coefficients are obtained by using the trial-and-error method, which may be costly and time consuming. In addition, when the rotational speed changes, the pole position of the observer system may undergo significant changes, which may greatly reduce the performance of the observer. Therefore, the feedback coefficients need to be adjusted automatically and efficiently to ensure the high performance of the observer.

### SUMMARY

In view of the problems described in the above section of background, the present disclosure is to provide a sensorless control method and system based on the Luenberger observer that is improved by proposed parameter selection method of obtaining optimal feedback coefficients. When the rotational speed affects the pole position, the feedback coefficients are automatically and efficiently adjusted to get better observer performance.

The present disclosure provides the technical solution as follows:

A sensorless control method of PMSM based on Luenberger observer includes the following steps:
Step 1: Taking sample of the three-phase current of the PMSM in real-time.
Step 2: Changing the three-phase current into the current under the stationary two-phase coordinate system.
Step 3: Constructing the Luenberger observer according to the resistance and inductance of the motor as well as the current and voltage under the two-phase stationary coordinate system.
Step 4: Calculating and selecting the appropriate feedback coefficient with the proposed selection method, and completing the construction of the Luenberger observer.
Step 5: Obtaining the estimated back-EMF through the Luenberger observer. Then calculating the estimated electrical angle by PLL (phase-locked loop), and consequently the estimated angular velocity can be obtained by this electrical angle.
Step 6: Establishing a speed closed-loop by using the estimated rotor position and the estimated speed. Meanwhile, obtaining the stator current under the two-phase rotational coordinate system, and then constructing the current closed-loop to obtain the stator voltage under the two-phase rotational coordinate system.
Step 7: Modulating SVPWM by using the stator voltage and the estimated rotor position under the two-phase rotational coordinate system. Then the controller outputs the corresponding PWM signal to the drive circuit, so that the motor stator generates a suitable rotating magnetic field to drag the rotor, and the sensorless FOC (Field Oriented Control) of the PMSM is completed.

As a further technical solution, the proposed coefficient selection method of the Luenberger observer in step 4 is described as follows:

The voltage balance equation of the surface-mounted PMSM in the stationary two-phase coordinate system is:

$$\{ \begin{matrix}{u}_{α} = {Ri}_{α} + L \frac{{di}_{α}}{dt} - ω {φ}_{f} sin θ \\ {u}_{β} = {Ri}_{β} + L \frac{{di}_{β}}{dt} - ω {φ}_{f} cos θ\end{matrix}$$

Where L is phase inductance of the motor, R is phase resistance of the motor, ω is the electric angular velocity of rotor, φ_{f} is the magnetic chain of stator. The back-EMF ωφ_{f} sin θ and ωφ_{f} cos θ are recorded as ea and ep, and rewrite the above formula as the state space expression of the PMSM as follows:

$$[ \begin{matrix}\frac{{di}_{α}}{dt} \\ \frac{{di}_{β}}{dt} \\ \frac{{de}_{α}}{dt} \\ \frac{{de}_{β}}{dt}\end{matrix} ] = [ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ] [ \begin{matrix}{i}_{α} \\ {i}_{β} \\ {e}_{α} \\ {e}_{β}\end{matrix} ] + [ \begin{matrix}\frac{1}{L} & 0 \\ 0 & \frac{1}{L} \\ 0 & 0 \\ 0 & 0\end{matrix} ] [ \begin{matrix}{u}_{α} \\ {u}_{β}\end{matrix} ]$$

$$[ \begin{matrix}{i}_{α} \\ {i}_{β}\end{matrix} ] = [ \begin{matrix}1 & 0 & 0 & 0 \\ 0 & 1 & 0 & 0\end{matrix} ] [ \begin{matrix}{i}_{α} \\ {i}_{β} \\ {e}_{α} \\ {e}_{β}\end{matrix} ]$$

Write

$$[ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ]$$

### as A, Write

$$[ \begin{matrix}\frac{1}{L} & 0 \\ 0 & \frac{1}{L} \\ 0 & 0 \\ 0 & 0\end{matrix} ]$$

### as B, Write

$$[ \begin{matrix}1 & 0 & 0 & 0 \\ 0 & 1 & 0 & 0\end{matrix} ]$$

as C. The A, B and C are the state matrix, input matrix and output matrix of the system respectively. Then the Luenberger observer can be constructed as:

$$[ \begin{matrix}\frac{dt}{} \\ \frac{dt}{} \\ \frac{dt}{} \\ \frac{dt}{}\end{matrix} ] = [ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ] [ \begin{matrix} \\ \\ \\ \end{matrix} ] + [ \begin{matrix}\frac{1}{L} & 0 \\ 0 & \frac{1}{L} \\ 0 & 0 \\ 0 & 0\end{matrix} ] [ \begin{matrix}{u}_{α} \\ {u}_{β}\end{matrix} ] + K [ \begin{matrix}{i}_{α} - \\ {i}_{β} -\end{matrix} ]$$

Since the PMSM is a nonlinear system, the relationship of the α axis and the β axis is nonlinear. The equations in the two-axis static coordinate system are symmetric, so the expression of the feedback matrix K can be expressed as follows:

$$K = [ \begin{matrix}{K}_{1} & 0 \\ 0 & {K}_{1} \\ {K}_{2} & 0 \\ 0 & {K}_{2}\end{matrix} ]$$

Wherein K₁ and K₂ are feedback coefficients which determine the performance of the observer.

The characteristic equation of the observer is:

$${\vert λ I - ( A - KC ) \vert = λ ( λ + {K}_{1} + \frac{R}{L} ) - \frac{{K}_{2}}{L} ]}^{2} + {( λ + {K}_{1} + \frac{R}{L} )}^{2} {ω}^{2} = {λ}^{4} + 2 ( \frac{R}{L} + {K}_{1} ) {λ}^{3} + ( {( \frac{R}{L} + {K}_{1} )}^{2} + {ω}^{2} - \frac{2 {K}_{2}}{L} ) {λ}^{2} + ( 2 {ω}^{2} - \frac{2 {K}_{2}}{L} ) ( \frac{R}{L} + {K}_{1} ) λ + {{ω}^{2} ( \frac{R}{L} + {K}_{1} )}^{2} + \frac{{K}_{2}^{2}}{{L}^{2}} = 0$$

As a further technical solution, rewrite the characteristic equation as:

$${( λ ( λ + {K}_{1} + \frac{R}{L} ) - \frac{{K}_{2}}{L} )}^{2} + {( λ + {K}_{1} + \frac{R}{L} )}^{2} {ω}^{2} = 0$$

And get a result as:

$$λ ( λ + {K}_{1} + \frac{R}{L} ) - \frac{{K}_{2}}{L} = \pm ( λ + {K}_{1} + \frac{R}{L} ) ω j$$

Two equations can be obtained from the above results:

$$λ ( λ + {K}_{1} + \frac{R}{L} ) - \frac{{K}_{2}}{L} - ( λ + {K}_{1} + \frac{R}{L} ) ω j = 0 \qquad ( 1 )$$

$$λ ( λ + {K}_{1} + \frac{R}{L} ) - \frac{{K}_{2}}{L} + ( λ + {K}_{1} + \frac{R}{L} ) ω j = 0 \qquad ( 2 )$$

Let the pole of the state observer λ=a+bj, substitute into Equation (1):

$${a}^{2} - {b}^{2} + ( \frac{R}{L} + {K}_{1} ) a + ω b - \frac{{K}_{2}}{L} + 2 abj + ( \frac{R}{L} + {K}_{1} ) bj - a ω j + ( {K}_{1} + \frac{R}{L} ) ω j = 0 \qquad ( 3 )$$

Because of the real part being equal to 0, the real part of the above Equation (3) can be written in the following form:

$${a}^{2} - {b}^{2} + ( \frac{R}{L} + {K}_{1} ) a + ω b - \frac{{K}_{2}}{L} = 0 \qquad ( 4 )$$

Because of the imaginary part being equal to 0, the imaginary part of the above Equation (3) can be written in the following form:

$${a}^{2} + ( \frac{R}{L} + {K}_{1} ) a + \frac{{ω}^{2} ( a + \frac{R}{L} + {K}_{1} ) a}{{( 2 a + \frac{R}{L} + {K}_{1} )}^{2}} - \frac{{K}_{2}}{L} = 0 \qquad ( 5 )$$

Equation (5) is equivalent to:

$${a}^{4} + 2 ( \frac{R}{L} + {K}_{1} ) {a}^{3} + ( \frac{5}{4} {( \frac{R}{L} + {K}_{1} )}^{2} + \frac{1}{4} {ω}^{2} - \frac{{K}_{2}}{L} ) {a}^{2} + ( \frac{1}{4} ( {( \frac{R}{L} + {K}_{1} )}^{3} + {ω}^{2} ( \frac{R}{L} + {K}_{1} ) ) - \frac{{K}_{2}}{L} ( \frac{R}{L} + {K}_{1} ) ) a - \frac{{K}_{2}}{4 L} {( \frac{R}{L} + {K}_{1} )}^{2} = 0 \qquad ( 6 )$$

Similarly, the same result can be obtained by Equation (2). Therefore, the real part within the characteristic root of the characteristic equation of the observer must satisfy the Equation (6). If all the real roots of Equation (6) are in a certain range, then the real part of the characteristic root will also fall in that range.

According to the above Equation (6), when R/L+K₁>0 and K₂<0, the coefficients of the Equation are bigger than 0, then the real roots of the equation are less than 0. That is to say, the real part within the characteristic roots of the observer are less than 0, so that the system is stable.

As a further technical solution, the dominant pole can be obtained as λ=−R/L from the state space equation. To achieve good system performance, the range of the observer pole should fall into the following range:

$${k}_{1} ( - \frac{R}{L} ) > a > {k}_{2} ( - \frac{R}{L} ) \qquad ( 7 )$$

Wherein k₁ and k₂ need to be selected according to experience, and integers between 2 and 10 are generally desirable for the values. In order to make the subsequent derivation more concise, let:

$$x = {k}_{1} ( \frac{R}{L} ) , y = {k}_{2} ( \frac{R}{L} )$$

In addition, Equation (6) can be written as the following form:

$$( 8 )$$

$$( a + {a}_{1} ) ( a + {a}_{2} ) ( a + {a}_{3} ) ( a + {a}_{4} ) = {a}^{4} + ( {a}_{1} + {a}_{2} + {a}_{3} + {a}_{4} ) {a}^{3} + ( {a}_{1} {a}_{2} + {a}_{1} {a}_{3} + {a}_{1} {a}_{4} + {a}_{2} {a}_{3} + {a}_{2} {a}_{4} + {a}_{3} {a}_{4} ) {a}^{2} + ( {a}_{1} {a}_{2} {a}_{3} + {a}_{1} {a}_{2} {a}_{4} + {a}_{1} {a}_{3} {a}_{4} + {a}_{2} {a}_{3} {a}_{4} ) a + {a}_{1} {a}_{2} {a}_{3} {a}_{4} = 0$$

Wherein a₁, a₂, a₃ and a₄ are arbitrary constants.

If the real part of the pole falls into the interval (−y, −x) for the observer, a₁, a₂, a₃ and a₄ are set in the interval (x, y), so:

$$x < {a}_{1} < y ; x < {a}_{2} < y ; x < {a}_{3} < y ; x < {a}_{4} < y \qquad ( 9 )$$

Then, the reference ranges of K₁ and K₂ are obtained by using the above range.

As a further technical solution, the following is derived from the above condition (9):

$$4 x < {a}_{1} + {a}_{2} + {a}_{3} + {a}_{4} < 4 y \qquad ( 10 )$$

$$6 {x}^{2} < {a}_{1} {a}_{2} + {a}_{1} {a}_{3} + {a}_{1} {a}_{4} + {a}_{2} {a}_{3} + {a}_{2} {a}_{4} + {a}_{3} {a}_{4} < 6 {y}^{2} \qquad ( 11 )$$

$$4 {x}^{3} < {a}_{1} {a}_{2} {a}_{3} + {a}_{1} {a}_{2} {a}_{4} + {a}_{1} {a}_{3} {a}_{4} + {a}_{2} {a}_{3} {a}_{4} < 4 {y}^{3} \qquad ( 12 )$$

$${x}^{4} < {a}_{1} {a}_{2} {a}_{3} {a}_{4} < {y}^{4} \qquad ( 13 )$$

Equations (6) and (8) are equal, so:

$$4 x < 2 ( \frac{R}{L} + {K}_{1} ) < 4 y \qquad ( 14 )$$

$$6 {x}^{2} < \frac{5}{4} {( \frac{R}{L} + {K}_{1} )}^{2} + \frac{1}{4} {ω}^{2} - \frac{{K}_{2}}{L} < 6 {y}^{2} \qquad ( 15 )$$

$$4 {x}^{3} < \frac{1}{4} ( {( \frac{R}{L} + {K}_{1} )}^{3} + {ω}^{2} ( \frac{R}{L} + {K}_{1} ) ) - \frac{{K}_{2}}{L} ( \frac{R}{L} + {K}_{1} ) < 4 {y}^{3} \qquad ( 16 )$$

$${x}^{4} < - \frac{{K}_{2}}{4 L} {( \frac{R}{L} + {K}_{1} )}^{2} < {y}^{4} \qquad ( 17 )$$

Simplifying inequality (14), it yields:

$$2 x < \frac{R}{L} + {K}_{1} < 2 y \qquad ( 18 )$$

By organizing Inequality (15), the range of K₂ can be expressed as:

$$- L ( 6 {y}^{2} - \frac{5}{4} {( \frac{R}{L} + {K}_{1} )}^{2} - \frac{1}{4} {ω}^{2} ) < {K}_{2} < - L ( 6 {x}^{2} - \frac{5}{4} {( \frac{R}{L} + {K}_{1} )}^{2} - \frac{1}{4} {ω}^{2} ) \qquad ( 19 )$$

By organizing Inequality (16), the range of K₂ can also be expressed as:

$$- L ( \frac{4 {y}^{3}}{( \frac{R}{L} + {K}_{1} )} - \frac{1}{4} ( {( \frac{R}{L} + {K}_{1} )}^{2} - \frac{1}{4} {ω}^{2} ) ) < {K}_{2} < - L ( \frac{4 {x}^{3}}{( \frac{R}{L} + {K}_{1} )} - \frac{1}{4} ( {( \frac{R}{L} + {K}_{1} )}^{2} - \frac{1}{4} {ω}^{2} ) ) \qquad ( 20 )$$

From Inequation (17), the range of K₂ can be written as:

$$\frac{- 4 {Ly}^{4}}{{( \frac{R}{L} + {K}_{1} )}^{2}} < {K}_{2} < \frac{- 4 {Lx}^{4}}{{( \frac{R}{L} + {K}_{1} )}^{2}} \qquad ( 21 )$$

From the above in equations, it can be inferred that when K₁ is determined, the range of K₂ can be calculated.

To obtain a more convenient and simpler expression, let the R/L+K₁ on the left of Inequation (19) equal to 2y, and let the R/L+K₁ on the right of Inequation (19) equal to 2x, so:

$$\frac{- 4 {Ly}^{4}}{{( \frac{R}{L} + {K}_{1} )}^{2}} < - L ( {y}^{2} - \frac{1}{4} {ω}^{2} ) < {K}_{2} < - L ( {x}^{2} - \frac{1}{4} {ω}^{2} ) < \frac{- 4 {Lx}^{4}}{{( \frac{R}{L} + {K}_{1} )}^{2}} \qquad ( 22 )$$

Inequality (22) can also be derived from Inequality (20), further verifying the correctness of Inequality (22).

By the same reason, get the following inequation from Inequation (21):

$$- L {y}^{2} < {K}_{2} < - {Lx}^{2} \qquad ( 23 )$$

By the above inequation, the feedback coefficients K₁ and K₂ can be selected in the following reference ranges:

$$\{ \begin{matrix}2 x - \frac{R}{L} < {K}_{1} < 2 y - \frac{R}{L} \\ - L ( {y}^{2} - \frac{1}{4} {ω}^{2} ) < {K}_{2} < - {Lx}^{2}\end{matrix} \qquad ( 24 )$$

When x and y are bigger than 0, it is known that R/L+K₁>0 and K₂<0, so the system meets the stability requirements.

It should be noted that the range of the feedback coefficient obtained by this method cannot guarantee that the pole of the system falls into the target range. Clearly, when the system poles fall within the target range, the feedback coefficients will inevitably fall within the range given by Inequality (24). Therefore, Inequations (24) can be used as the reference range to select the feedback coefficient under the condition that the stability is satisfied. Furthermore, when the rotation speed affects the pole position of the observer greatly, the feedback coefficient can be adjusted to some extent according to the Inequations (24).

The present invention also provides a PMSM sensorless control system based on Luenberger observer, including a power supply circuit, a sampling circuit, a main control circuit, a drive circuit.

The power supply circuit is connected to a DC power. The energy supply of other circuits comes from the power supply circuit.

The sampling circuit is connected to the PMSM, collecting the two-end voltage of the sampling resistance in series connection on each phase of the three-phase PMSM, and transmits the signal to the main control chip to calculate the three-phase current.

The main control circuit is connected to the drive circuit, and the output control signal is sent to the drive circuit to drive the motor.

By employing the technical solution described above, compared with the prior art, the present disclosure has the beneficial effects as follows:
1) In the present disclosure, a new selection method of Luenberger observer is proposed for selecting feedback coefficient, which is more convenient and effective than conventional method does. Specifically, with obtaining motor parameters in advance, it is quickly to get a small reference range of feedback coefficient according to the inequations given by this present disclosure, and consequently the observer performance can be guaranteed.
2) In the present disclosure, the stability conditions of the observer system are given, which ensure the stability of the system.
3) In the present disclosure, we have made good use of global parameters. In other words, the feedback coefficient can be automatically adjusted by the Inequations given in this present methodology to get better observer performance, especially when the rotation speed fluctuation has a great influence on the pole position of the observer.
4) In conclusion, suitable feedback coefficients can be obtained quickly by the improved Luenberger observer. This Luenberger observer has a good adaptive ability so that the control system achieve more stable performance, and its response is very fast.

### BRIEF DESCRIPTION OF THE DRAWINGS

FIG. 1 is a structure diagram of the PMSM control system provided in the present embodiment;

FIG. 2 is a schematic diagram of the power supply circuit provided in this embodiment;

FIG. 3 is a schematic diagram of the sampling circuit provided in this embodiment;

FIG. 4 is a schematic diagram of the main control circuit provided in this embodiment;

FIG. 5 is a schematic diagram of the drive circuit provided in this embodiment;

FIG. 6 is a flow chart of the feedback coefficient selection method provided in this embodiment;

FIG. 7 is a block diagram of the Luenberger observer structure provided in this embodiment;

FIG. 8 is a simulation model of a PMSM using the improved Luenberger observer provided in this embodiment;

FIG. 9 is a simulation diagram of the rotor position estimation under the sudden change of rotational speed as provided in this embodiment;

FIG. 10 is a simulation diagram of the current measurement value and the observer current estimation of the α phase when the feedback coefficients are K₁=360 and K₂=−180 provided in this embodiment;

### DETAILED DESCRIPTION OF THE EMBODIMENTS

In order to make the objective, technical solution, and advantages of the present disclosure much more clearer and easier to understand, the present disclosure is further described in detail below with reference to the accompanying drawings. It should be understood that the specific embodiments described herein are merely illustrative of the present disclosure, and not intended to limit the present disclosure.

On the contrary, the present disclosure is to encompass any alternatives, modifications, equivalents, and solutions made within the spirit and scope of the present disclosure, as defined by the appended claims. Further, in the follow detailed description of the present disclosure, some specific details are described thoroughly, so that people will have a better understanding of the present disclosure. Those skilled in the art may also fully understand the present disclosure without these details.

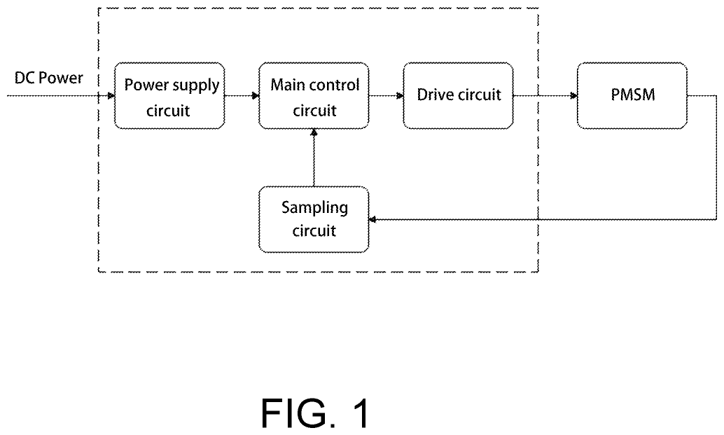

As shown in FIG. 1 is the structure diagram of the PMSM control system of the present invention. The system includes a power supply circuit, a sampling circuit, a main control circuit and a drive circuit. The external DC power is connected to the power supply circuit.

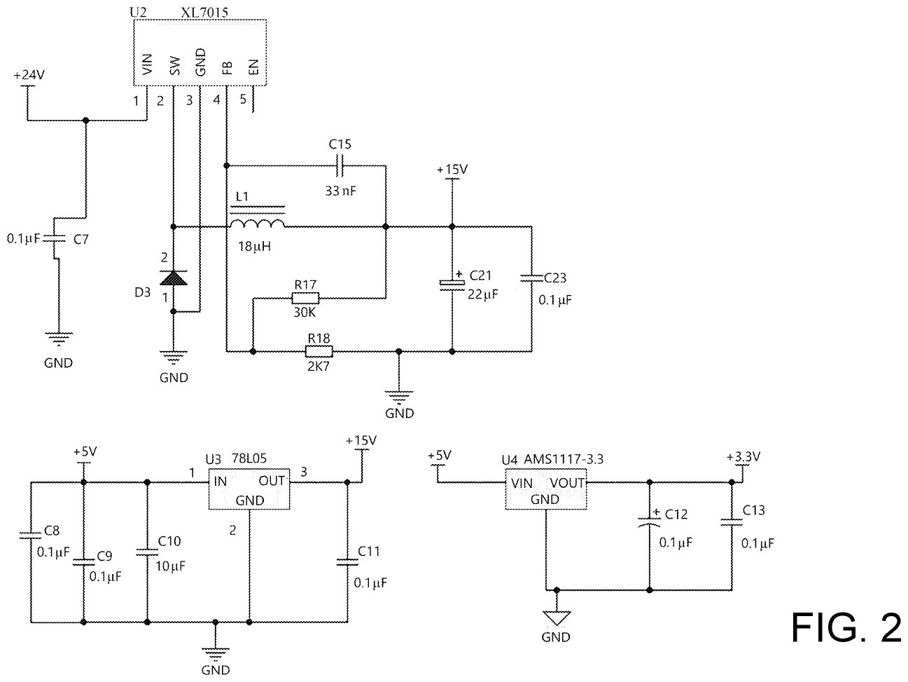

As shown in FIG. 2, it is a schematic diagram of the power supply circuit of a specific embodiment of the present invention. There are three BUCK circuits that reduce the DC power voltage to 15V, 5V and 3.3V respectively. Wherein 15V supplies power for the drive circuit, and 3.3V for the main control circuit.

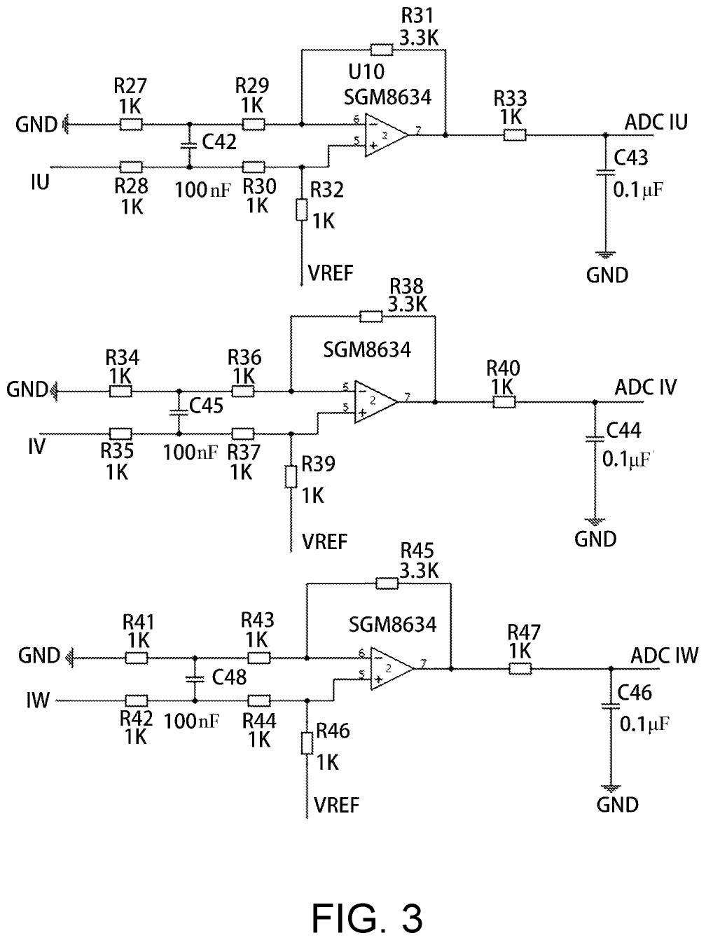

As shown in FIG. 3, it is a schematic diagram of the sampling circuit of a specific embodiment of the present invention. The circuit amplifies the two-end voltage of the sampling resistance through an operational amplifier, and then transmits the amplified voltage signal to the main control chip. The sampled current can be calculated by using the voltage signal and the value of sampling resistance.

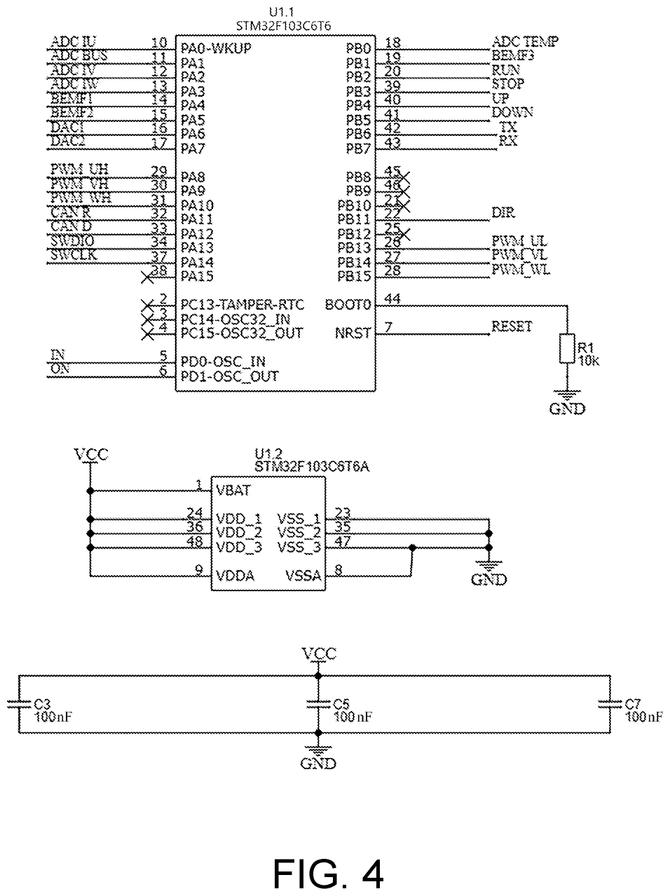

As shown in FIG. 4, it is a schematic diagram of the main control circuit of a specific embodiment of the present invention. It consists of a microcontroller and its peripheral circuit. The microcontroller can perform the motor control algorithm, and output the control signal to the drive circuit.

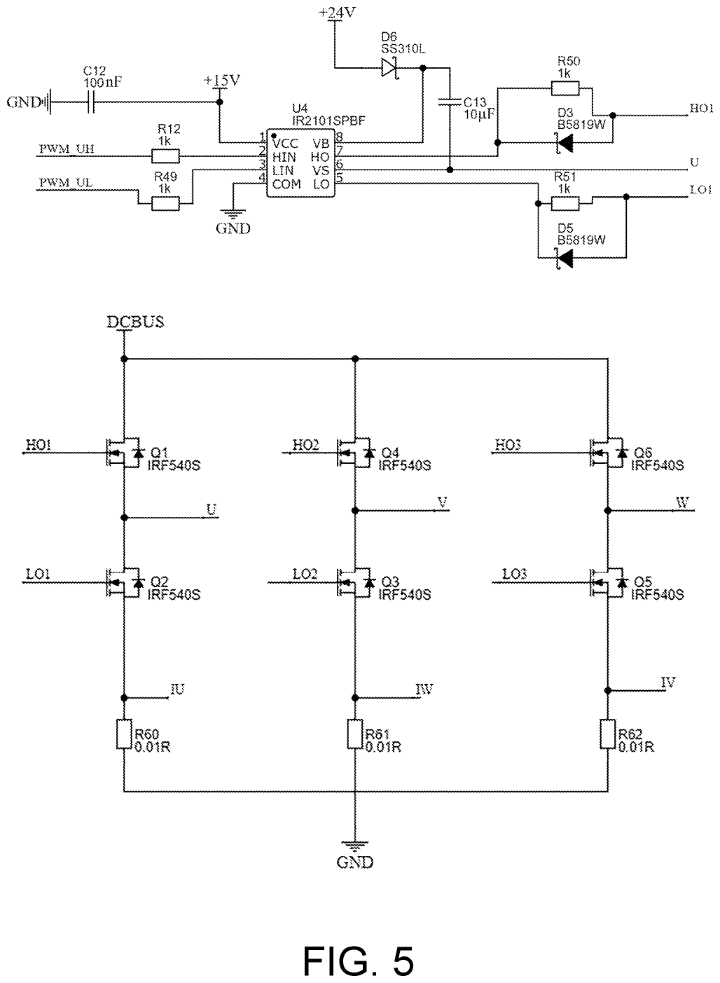

As shown in FIG. 5, it is a schematic diagram of the drive circuit of a specific embodiment of the present invention, consisting of a pre-drive circuit and a three-phase full-bridge inverting circuit. The pre-drive circuit changes the switching state of the MOSFET in the circuit, according to the input control signal to drive the motor.

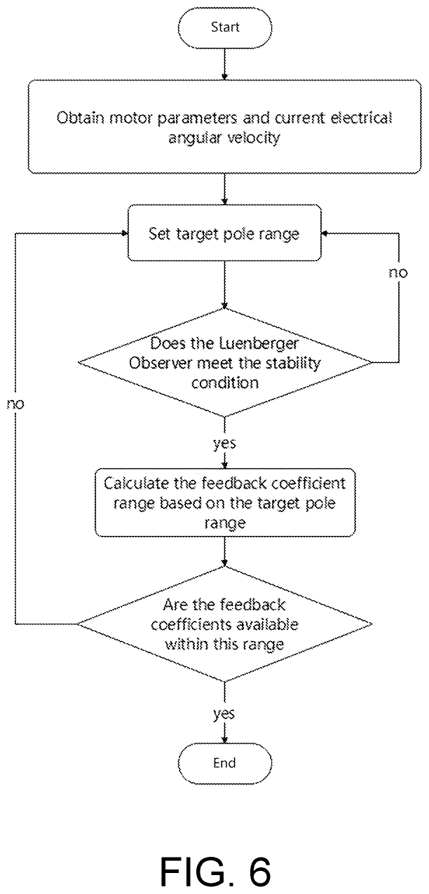

The specific process of the motor control algorithm is as follows:
1) Starting the motor with open-loop manner, and running the motor at a certain speed level, three-phase circuit of Iₐ, I_{b}, I_{c} can be obtained by sampling.
2) The three-phase current and the given three-phase voltage are transformed by the Clack Transformation, so the stator currents of I_{α}, I_{β} as well as the voltages of U_{α}, U_{β} can be obtained in the Two-phase stationary coordinate system.
3) The Luenberger observer is then constructed in the two-phase stationary coordinate system, according to the motor parameter of resistance R and inductor L.
4) The improved selection method on feedback coefficient of Luenberger observer is used to obtain the appropriate feedback coefficient quickly, and the observer have good performance in a wide speed range. The concrete procedure of the improved selection method is shown in FIG. 6 for selecting feedback coefficient.
5) After the estimated back-EMF is obtained using the Luenberger observer, the PLL is used to obtain the estimated rotor position θ and the estimated rotational speed ω.
6) I_{α}, I_{β} are transformed to the stator current of I_{d}, I_{q} in the two-phase rotational coordinate system by Park Transformation. And then, according to the estimated speed w and the given target speed wo, the speed closed-loop is established, the output of which are the target current I_{d0} and I_{q0}. Then, the current closed-loop is constructed using the current of I_{d}, I_{q}, then obtaining the stator voltages of U_{d}, U_{q} in the two-phase rotational coordinate system. After that, the Anti-Park Transformation is used to obtain the new stator voltages of U_{α}, U_{β} in the two-phase stationary coordinate system.
7) Finally, the SVPWM (Space Vector Pulse Width Modulation) is modulated with U_{α} and U_{β}, so the sensorless control of the PMSM is realized.

Table 1 lists the PMSM parameters provided in this embodiment. Next, take this motor as an example to illustrate the selection method on feedback coefficient with the improved Luenberger observer.

TABLE 1
Parameters of PMSM adopted in present example

| | |
|---|---|
| Rated Voltage (V) | 24 |
| The Number of Pole-pairs | 2 |
| Phase Resistance (Ω) | 0.3 |
| Phase Inductance (H) | 0.000375 |
| Counter Electromotive Force Constant (V · kRPM) | 6.23 |
| Rotational Inertia (g · cm²) | 120 |

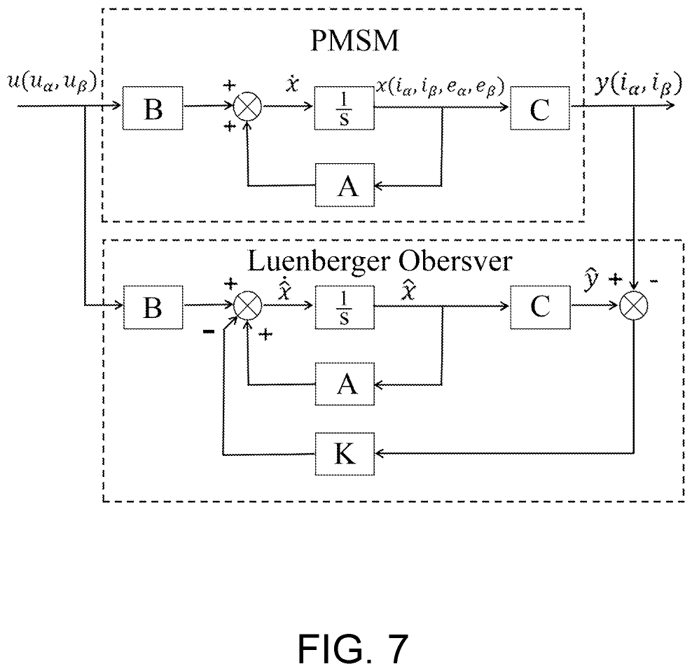

As shown in FIG. 7, the structure diagram of the Luenberger observer is provided in this embodiment. The A, B, and C are the state matrix, input matrix and output matrix of the system respectively. The K is the feedback gain matrix. The parameters K₁ and K₂ in the feedback matrix are the feedback coefficients which determine the performance of the observer. Therefore, the feedback coefficients are the key to design Luenberger observer. By utilizing the parameter selection method adopted by the improved Luenberger observer, good feedback coefficients can be quickly obtained, including the following steps:

Step 1: according to the system state matrix A, the poles of the motor control system can be obtained as:

$${λ}_{1 , 2} = - \frac{R}{L} , {λ}_{3 , 4} = \pm jp ω$$

Considering the main poles of the system λ_{1,2}, substitute the motor parameters into the above equation to obtain λ_{1,2}=−800.

Step 2: the target pole range is given as:

$$0 > {k}_{1} ( - \frac{R}{L} ) > {λ}_{1 , 2 , 3 , 4} > {k}_{2} ( - \frac{R}{L} )$$

Taking k₁=2.5, k₂=3 by experience:

$$x = {k}_{1} ( \frac{R}{L} ) = 2000$$

$$y = {k}_{2} ( \frac{R}{L} ) = 2400$$

Step 3: Giving the selection range of the feedback coefficient through the following in equations:

$$\{ \begin{matrix}2 x - \frac{R}{L} < {K}_{1} < 2 y - \frac{R}{L} \\ - L ( {y}^{2} - \frac{1}{4} {ω}^{2} ) < {K}_{2} < - {Lx}^{2}\end{matrix}$$

The results are obtained by substituting x, y, R and L into the above in equations, which are given as:

$$\{ \begin{matrix}3200 < {K}_{1} < 4000 \\ - 2160 + 0.09375 {ω}^{2} < {K}_{2} < - 1500\end{matrix}$$

The values of K₁, K₂ can be selected within the above range according to the actual value of the electric angular speed. Generally, the middle value is selected between the above range.

In order to make the observer perform well in the wide speed range, taking the electric angular speed equal to 0, the K₁, K₂ will fall into the following range:

$$\{ \begin{matrix}3200 < {K}_{1} < 4000 \\ - 2160 < {K}_{2} < - 1500\end{matrix}$$

And taking the electric angular speed equal to the maximum, for example ω=1000, then:

$$\{ \begin{matrix}3200 < {K}_{1} < 4000 \\ - 2066 < {K}_{2} < - 1500\end{matrix}$$

To sum up the above steps, K₁=3600 and K₂=−1800 are recommended accordingly, which make the PMSM run stably in the wide speed range.

Step 4: Verifying the stability condition of R/L+K₁>0 and K₂<0, and the obtained parameters herein can stabilize the control system.

Step 5: Conducting parameter debugging. If the obtained parameters make the observer performance poor, then return to step 2 to give another target pole range. Generally, the selected k₁ is not less than 2, the k₂ is not more than 10, so taking the multiple of 0.5 as the debugging factor.

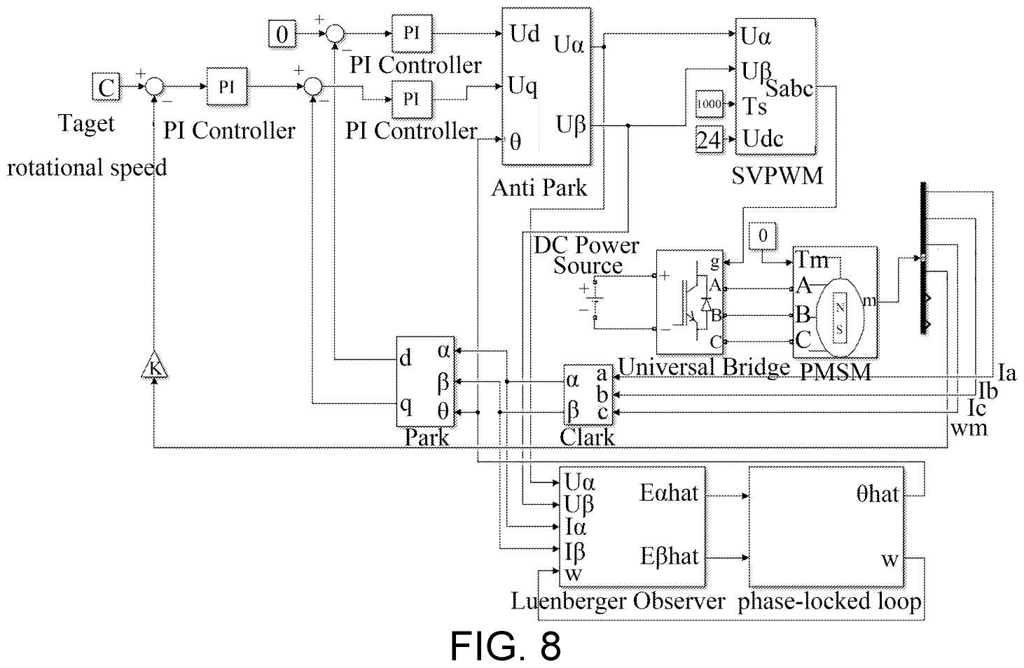

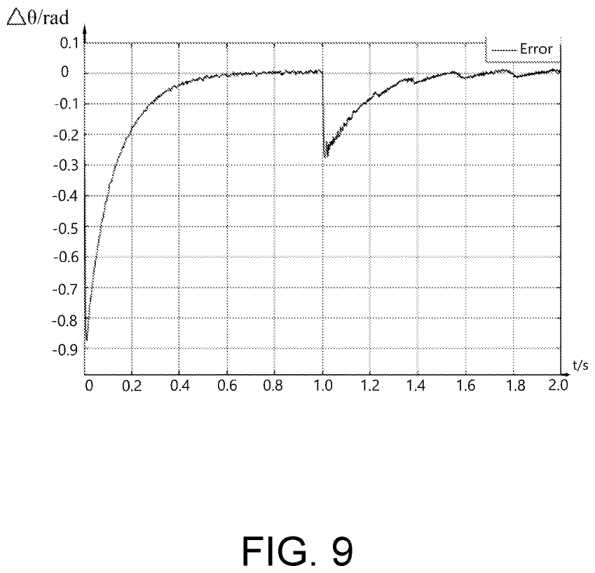

As shown in FIG. 8, the simulation model is established through the Simulink module of MATLAB, using the motor parameters given in Table 1. The Luenberger observer is constructed with the feedback coefficients selected by Step 3. During the simulation, the motor speed is accelerated from 1000 r/min to 2500 r/min after 1 second in the simulation. The difference Δθ between the actual and estimated values of the electric angle is shown in FIG. 9. The convergence rate of the observer error is relatively fast, and it can also be converged quickly when the rotational speed fluctuation takes place, which has a good performance in the wide speed range.

The improved Luenberger observer is designed with the selected parameter, which has good performance in this embodiment.

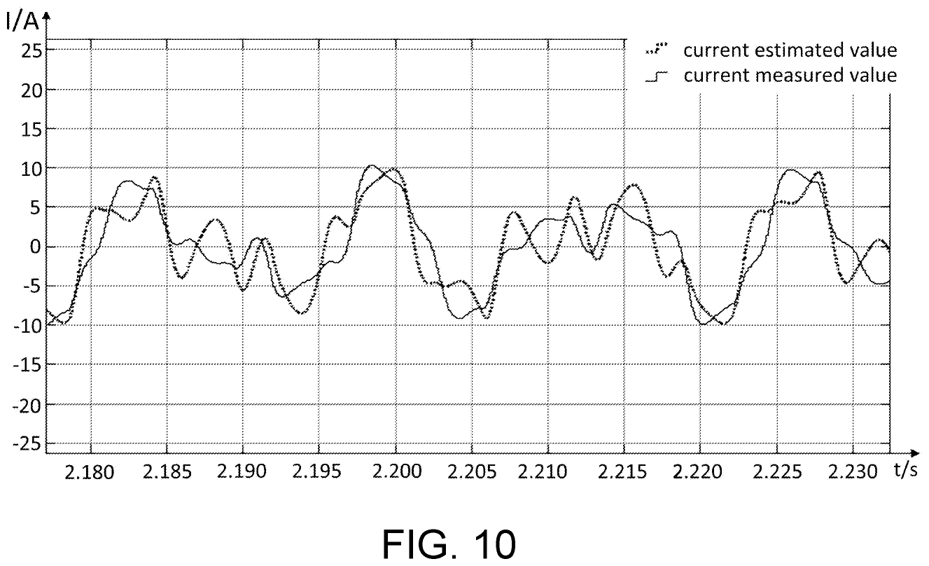

It is worth noting that the feedback coefficients can almost only be found by referring to stability conditions, if use the trial-and-error method. For example, the stability condition of this embodiment is K₁>−800 and K₂<0, which is a very broad range. The performance of the observer may not meet the application requirements if the feedback coefficient is randomly selected within this broad range. FIG. 10 shows the current measurements and observer current estimations of the a phase with the feedback coefficient of K₁=360 and K₂=−180. It can be seen that although the feedback coefficient satisfies the stability condition, the error between the measurement and estimation is unacceptably large, and the motor does not run properly. It will take more time for debugging to find the right value. In addition, the feedback coefficient obtained by the trial-and-error method may only be suitable for a certain speed segment. When the rotating speed changes greatly, the observer performance may not reach the target level, so it takes more time to carry out parameter debugging by using traditional method.

What is claimed is:

1. A sensorless control method of PMSM, comprising:
Step 1-1: taking sample of a three-phase current of the PMSM in real time;
Step 1-2: changing the three-phase current into a current under a stationary two-phase coordinate system;
Step 1-3: constructing a Luenberger observer by using a resistance and inductance of a motor as well as the current and voltage under a two-phase stationary coordinate system;
Step 1-4: calculating and selecting a appropriate feedback coefficient with a selection method, and completing the construction of the Lemberger observer;
Step 1-5: obtaining an estimated back-EMF through the Luenberger observer, and obtaining an estimated electrical angle by PLL, and subsequently an estimated angular velocity is obtained by the estimated electrical angle;
Step 1-6: establishing a speed closed-loop according to an estimated rotor position and an estimated speed, and obtaining a stator current under an two-phase rotational coordinate system, and constructing a current closed-loop to obtain a stator voltage under the two-phase rotational coordinate system;
Step 1-7: modulating SVPWM according to the stator voltage and the estimated rotor position under the two-phase rotational coordinate system, and a controller outputs a corresponding PWM signal to a drive circuit, so that a motor stator generates a suitable rotating magnetic field to drag the rotor, and a sensorless FOC of the PMSM is completed.

2. The sensorless control method of PMSM according to claim 1, wherein the step 1-4 is further comprises:
Step 2-1: conducting a stability analysis of the Luenberger observer;
Step 2-2: obtaining a target pole range of an observer system according to a pole of a motor system;
Step 2-3: deducing a ranges of an observer feedback coefficients from the target pole range, and selecting a appropriate feedback coefficients within the range;
Step 2-4: adjusting the target pole range of a given observer system, and repeating the above steps if the feedback coefficients are still unsuitable after debugging.

3. The sensorless control method of PMSM according to claim 1, wherein the PMSM is a surface-mounted motor, and a voltage balance equation in two-phase stationary coordinate system is formulated as:
$$\{ \begin{matrix}{u}_{α} = {Ri}_{α} + L \frac{{di}_{α}}{dt} - ω {φ}_{f} sin θ \\ {u}_{β} = {Ri}_{β} + L \frac{{di}_{β}}{dt} - ω {φ}_{f} cos θ\end{matrix}$$
Wherein, L is a motor phase inductance, R is a motor phase resistance, ω is an electric angular velocity of rotor, φ_{f} is a magnetic chain of stator, wherein back-EMF ωφ_{f} sin θ and ωφ_{f} cos θ are recorded as e_{α} and e_{β}, and the above formula as a state space expression of the PMSM is rewritten as follows:
$$[ \begin{matrix}\frac{{di}_{α}}{dt} \\ \frac{{di}_{β}}{dt} \\ \frac{{de}_{α}}{dt} \\ \frac{{de}_{β}}{dt}\end{matrix} ] = [ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ] [ \begin{matrix}{i}_{α} \\ {i}_{β} \\ {e}_{α} \\ {e}_{β}\end{matrix} ] + [ \begin{matrix}\frac{1}{L} & 0 \\ 0 & \frac{1}{L} \\ 0 & 0 \\ 0 & 0\end{matrix} ] [ \begin{matrix}{u}_{α} \\ {u}_{β}\end{matrix} ]$$
$$[ \begin{matrix}{i}_{α} \\ {i}_{β}\end{matrix} ] = [ \begin{matrix}1 & 0 & 0 & 0 \\ 0 & 1 & 0 & 0\end{matrix} ] [ \begin{matrix}{i}_{α} \\ {i}_{β} \\ {e}_{α} \\ {e}_{β}\end{matrix} ]$$
Write
$$[ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ]$$
as A, Write
$$[ \begin{matrix}\frac{1}{L} & 0 \\ 0 & \frac{1}{L} \\ 0 & 0 \\ 0 & 0\end{matrix} ]$$
as B, Write
$$[ \begin{matrix}1 & 0 & 0 & 0 \\ 0 & 1 & 0 & 0\end{matrix} ]$$
as C, the A, B and C are the state matrix, input matrix and output matrix of the system respectively.

4. The sensorless control method of PMSM according to claim 2, wherein the Luenberger observer constructed as:
$$[ \begin{matrix}\frac{dt}{} \\ \frac{dt}{} \\ \frac{dt}{} \\ \frac{dt}{}\end{matrix} ] = [ \begin{matrix}- \frac{R}{L} & 0 & - \frac{1}{L} & 0 \\ 0 & - \frac{R}{L} & 0 & - \frac{1}{L} \\ 0 & 0 & 0 & - ω \\ 0 & 0 & ω & 0\end{matrix} ] [ \begin{matrix} \\ \\ \\ \end{matrix} ] + [ \begin{matrix}\frac{1}{L} & 0 \\ 0 & \frac{1}{L} \\ 0 & 0 \\ 0 & 0\end{matrix} ] [ \begin{matrix}{u}_{α} \\ {u}_{β}\end{matrix} ] + K [ \begin{matrix}{i}_{α} - \\ {i}_{β} -\end{matrix} ]$$
wherein the PMSM is a nonlinear system, the relationship of various parameters between the α axis and the β axis is nonlinear, and the Equations in a static two-axis coordinate system are symmetric, so a expression of the feedback matrix K expressed as follows:
$$K = [ \begin{matrix}{K}_{1} & 0 \\ 0 & {K}_{1} \\ {K}_{2} & 0 \\ 0 & {K}_{2}\end{matrix} ]$$
Wherein, K₁ and K₂ are feedback coefficients which determine the performance of the observer.

5. The sensorless control method of PMSM according to claim 2, wherein the observer stability is achieved as follows:
wherein a characteristic equation of the observer is:
$${\vert λ I - ( A - KC ) \vert = λ ( λ + {K}_{1} + \frac{R}{L} ) - \frac{{K}_{2}}{L} ]}^{2} + {( λ + {K}_{1} + \frac{R}{L} )}^{2} {ω}^{2} = {λ}^{4} + 2 ( \frac{R}{L} + {K}_{1} ) {λ}^{3} + ( {( \frac{R}{L} + {K}_{1} )}^{2} + {ω}^{2} - \frac{2 {K}_{2}}{L} ) {λ}^{2} + ( 2 {ω}^{2} - \frac{2 {K}_{2}}{L} ) ( \frac{R}{L} + {K}_{1} ) λ + {{ω}^{2} ( \frac{R}{L} + {K}_{1} )}^{2} + \frac{{K}_{2}^{2}}{{L}^{2}} = 0$$
As a further technical solution, rewrite the characteristic equation as:
$${( λ ( λ + {K}_{1} + \frac{R}{L} ) - \frac{{K}_{2}}{L} )}^{2} + {( λ + {K}_{1} + \frac{R}{L} )}^{2} {ω}^{2} = 0$$
And get a result as:
$$λ ( λ + {K}_{1} + \frac{R}{L} ) - \frac{{K}_{2}}{L} = \pm ( λ + {K}_{1} + \frac{R}{L} ) ω j$$
Wherein, two equations obtained from the above results:
$$λ ( λ + {K}_{1} + \frac{R}{L} ) - \frac{{K}_{2}}{L} - ( λ + {K}_{1} + \frac{R}{L} ) ω j = 0 \qquad ( 5 - 1 )$$
$$λ ( λ + {K}_{1} + \frac{R}{L} ) - \frac{{K}_{2}}{L} + ( λ + {K}_{1} + \frac{R}{L} ) ω j = 0 \qquad ( 5 - 2 )$$
Let the pole of the state observer λ=a+bj, substitute into Equation (5-1):
$${a}^{2} - {b}^{2} + ( \frac{R}{L} + {K}_{1} ) α + ω b - \frac{{K}_{2}}{L} + 2 abj + ( \frac{R}{L} + {K}_{1} ) bj - α ω j + ( {K}_{1} + \frac{R}{L} ) ω j = 0 \qquad ( 5 - 3 )$$
Wherein, the real part must be equal to 0:
$${a}^{2} - {b}^{2} + ( \frac{R}{L} + {K}_{1} ) a + ω b - \frac{{K}_{2}}{L} = 0 \qquad ( 5 - 4 )$$
Wherein, the imaginary part is equal to 0:
$${a}^{2} + ( \frac{R}{L} + {K}_{1} ) a + \frac{{ω}^{2} ( a + \frac{R}{L} + {K}_{1} ) a}{{( 2 a + \frac{R}{L} + {K}_{1} )}^{2}} - \frac{{K}_{2}}{L} = 0 \qquad ( 5 - 5 )$$
Change the form of Equation (5-5), which written as:
$${a}^{4} + 2 ( \frac{R}{L} + {K}_{1} ) {a}^{3} + ( \frac{5}{4} {( \frac{R}{L} + {K}_{1} )}^{2} + \frac{1}{4} {ω}^{2} - \frac{{K}_{2}}{L} ) {a}^{2} + ( \frac{1}{4} ( {( \frac{R}{L} + {K}_{1} )}^{3} + {ω}^{2} ( \frac{R}{L} + {K}_{1} ) ) - \frac{{K}_{2}}{L} ( \frac{R}{L} + {K}_{1} ) ) a - \frac{{K}_{2}}{4 L} {( \frac{R}{L} + {K}_{1} )}^{2} = 0 \qquad ( 5 - 6 )$$
Wherein, the real part of the characteristic root of the observer must satisfy the Equation (5-6), and if all the real roots of Equation (5-6) are in a certain range, then the real part of the characteristic root inevitably fall in that range, and
According to the Equation (5-6), when R/L+K₁>0 and K₂<0, the coefficients of the Equation are bigger than 0, then the real roots of the equation are less than 0, the real part of the characteristic roots are less than 0 for the observer characteristic equation.

6. The sensorless control method of PMSM according to claim 2, a specific mode of target pole range in the step 2-2 comply with the following rules:
As a further technical solution, a dominant pole obtained as λ=−R/L from a state space equation, and the range of the observer pole described as:
$${k}_{1} ( - \frac{R}{L} ) > a > {k}_{2} ( - \frac{R}{L} )$$
Wherein, integers between 2 and 10 are generally desirable, and
$$x = {k}_{1} ( \frac{R}{L} ) , y = {k}_{2} ( \frac{R}{L} ) .$$

7. The sensorless control method of PMSM according to claim 2, the feedback coefficient of the observer in the step 2-3 is derived in the followings:
Firstly, Equation (5-6) written as the following form:
$$( a + {a}_{1} ) ( a + {a}_{2} ) ( a + {a}_{3} ) ( a + {a}_{4} ) = {a}^{4} + ( {a}_{1} + {a}_{2} + {a}_{3} + {a}_{4} ) {a}^{3} + ( {a}_{1} {a}_{2} + {a}_{1} {a}_{3} + {a}_{1} {a}_{4} + {a}_{2} {a}_{3} + {a}_{2} {a}_{4} + {a}_{3} {a}_{4} ) {a}^{2} + ( {a}_{1} {a}_{2} {a}_{3} + {a}_{1} {a}_{2} {a}_{4} + {a}_{1} {a}_{3} {a}_{4} + {a}_{2} {a}_{3} {a}_{4} ) a + {a}_{1} {a}_{2} {a}_{3} {a}_{4} = 0 \qquad ( 7 - 1 )$$
Wherein, a₁, a₂, a₃ and a₄ are arbitrary constants, and
if the real part of the pole falls into the interval (−y, −x) for the observer, a₁, a₂, a₃ and a₄ can be set in the interval (x, y), so:
$$x < {a}_{1} < y ; x < {a}_{2} < y ; x < {a}_{3} < y ; x < {a}_{4} < y \qquad ( 7 - 2 )$$
As a further technical solution, the following is derived from the above inequalities (7-2):
$$4 x < {a}_{1} + {a}_{2} + {a}_{3} + {a}_{4} < 4 y$$
$$6 {x}^{2} < {a}_{1} {a}_{2} + {a}_{1} {a}_{3} + {a}_{1} {a}_{4} + {a}_{2} {a}_{3} + {a}_{2} {a}_{4} + {a}_{3} {a}_{4} < 6 {y}^{2}$$
$$4 {x}^{3} < {a}_{1} {a}_{2} {a}_{3} + {a}_{1} {a}_{2} {a}_{4} + {a}_{1} {a}_{3} {a}_{4} + {a}_{2} {a}_{3} {a}_{4} < 4 {y}^{3}$$
$${x}^{4} < {a}_{1} {a}_{2} {a}_{3} {a}_{4} < {y}^{4}$$
Comparing Equation (5-6) with Equation (7-1), the following inequalities established:
$$4 x < 2 ( \frac{R}{L} + {K}_{1} ) < 4 y \qquad ( 7 - 3 )$$
$$6 {x}^{2} < \frac{5}{4} {( \frac{R}{L} + {K}_{1} )}^{2} + \frac{1}{4} {ω}^{2} - \frac{{K}_{2}}{L} < 6 {y}^{2} \qquad ( 7 - 4 )$$
$$4 {x}^{3} < \frac{1}{4} ( {( \frac{R}{L} + {K}_{1} )}^{3} + {ω}^{2} ( \frac{R}{L} + {K}_{1} ) ) - \frac{{K}_{2}}{L} ( \frac{R}{L} + {K}_{1} ) < 4 {y}^{3} \qquad ( 7 - 5 )$$
$${x}^{4} < - \frac{{K}_{2}}{4 L} {( \frac{R}{L} + {K}_{1} )}^{2} < {y}^{4} \qquad ( 7 - 6 )$$
From Inequation (7-3), the range of K₁ known as:
$$2 x < \frac{R}{L} + {K}_{1} < 2 y \qquad ( 7 - 7 )$$
From Inequation (7-4), the range of K₂ described as:
$$- L ( 6 {y}^{2} - \frac{5}{4} {( \frac{R}{L} + {K}_{1} )}^{2} - \frac{1}{4} {ω}^{2} ) < {K}_{2} < - L ( 6 {x}^{2} - \frac{5}{4} {( \frac{R}{L} + {K}_{1} )}^{2} - \frac{1}{4} {ω}^{2} ) \qquad ( 7 - 8 )$$
From Inequation (7-5), the range of K₂ described as:
$$- L ( \frac{4 {y}^{3}}{( \frac{R}{L} + {K}_{1} )} - \frac{1}{4} ( {( \frac{R}{L} + {K}_{1} )}^{2} - \frac{1}{4} {ω}^{2} ) ) < {K}_{2} < - L ( \frac{4 {x}^{3}}{( \frac{R}{L} + {K}_{1} )} - \frac{1}{4} ( {( \frac{R}{L} + {K}_{1} )}^{2} - \frac{1}{4} {ω}^{2} ) ) \qquad ( 7 - 9 )$$
From Inequation (7-6), the range of K₂ written as:
$$\frac{- 4 {Ly}^{4}}{{( \frac{R}{L} + {K}_{1} )}^{2}} < {K}_{2} < \frac{- 4 {Lx}^{4}}{{( \frac{R}{L} + {K}_{1} )}^{2}} \qquad ( 7 - 10 )$$
From above in equations, when K₁ is determined, a range of K₂ determined accordingly, wherein, the R/L+K₁ on the left of inequation (7-8) equal to 2y, and let the R/L+K₁ on the right of inequation (7-8) equal to 2x, so:
$$\frac{- 4 {Ly}^{4}}{{( \frac{R}{L} + {K}_{1} )}^{2}} < - L ( {y}^{2} - \frac{1}{4} {ω}^{2} ) < {K}_{2} < - L ( {x}^{2} - \frac{1}{4} {ω}^{2} ) < \frac{- 4 {Lx}^{4}}{{( \frac{R}{L} + {K}_{1} )}^{2}} \qquad ( 7 - 11 )$$
wherein, the same result presented by inequation (7-11) obtained from inequation (7-9), get the following Inequation from Inequation (7-10):
$$- {Ly}^{2} < {K}_{2} < - {Lx}^{2} \qquad ( 7 - 12 )$$
By the above in equations, the feedback coefficients K₁ and K₂ selected in the following reference ranges:
$$\{ \begin{matrix}2 x - \frac{R}{L} < {K}_{1} < 2 y - \frac{R}{L} \\ - L ( {y}^{2} - \frac{1}{4} {ω}^{2} ) < {K}_{2} < - {Lx}^{2}\end{matrix} \qquad ( 7 - 13 )$$
Wherein x and y are bigger than 0, it is known that R/L+K₁>0 and K₂<0, so the system meets the stability requirements.

8. The sensorless control method of PMSM according to claim 1, further comprises:
a sensorless control system based on Luenberger observer is established and designed for running the PMSM.

9. The sensorless control method of PMSM according to claim 8, the sensorless control system includes a power supply circuit, a sampling circuit, a main control circuit, and a drive circuit:
Wherein the power supply circuit is connected to a DC power, an energy supply of other circuits comes from the power supply circuit,
Wherein the sampling circuit is connected to the PMSM, collecting two-end voltage of a sampling resistance in series connection on each phase of three-phase PMSM, it transmits the signal to a main control chip to calculate three-phase current,
Wherein the main control circuit is connected to the drive circuit, an output control signal is sent to the drive circuit to drive the motor.
